(19) United States
(12) Patent Application Publication
(10) Pub. No.: US 2015/0110945 A1
(43) Pub. Date: Apr. 23, 2015

(54) SALT REDUCED EMULSIFIED MEAT PRODUCTS

(71) Applicant: DuPont Nutrition Biosciences ApS, Copenhagen K (DK)

(72) Inventor: Jesper Kampp, Skanderborg (DK)

(73) Assignee: DuPont Nutrition Biosciences ApS, Copenhagen K (DK)

(21) Appl. No.: 14/398,197

(22) PCT Filed: Apr. 25, 2013
(86) PCT No.: PCT/EP2013/058604

§ 371 Date: Oct. 31, 2014

Related U.S. Application Data
(60) Provisional application No. 61/642,146, filed on May 3, 2012.

(30) Foreign Application Priority Data
May 3, 2012 (EP) 12166592.1

(51) Int. Cl. A23L 1/314; A23L 1/317

(52) U.S. Cl. CPC A23L 1/31454; A23L 1/31418; A23L 1/3175; A23V 2002/00
USPC 426/646

(57) ABSTRACT

The present invention relates to an emulsifier for use in a salt reduced meat product, a method of using said emulsifier for emulsifying a salt reduced meat product and an emulsified, salt reduced meat product. The emulsifier is selected from salts of fatty acids containing C12-C22, which meat product comprises less than 1.8% w/w NaCl.

### FIELD OF THE INVENTION

The present invention relates to an emulsifier for use in a salt reduced meat product, a method of using said emulsifier for emulsifying a salt reduced meat product and an emulsified, salt reduced meat product.

### BACKGROUND OF THE INVENTION

Thickeners and gelling agents are well-known ingredients in the meat industry. Canageenans and starches are widely used to bind water in injected meat products like ham as well as in diminished meat products like sausages. In addition, hydrocolloids like gelatine are used in meat related products like aspic, coatings and the like.

Sodium chloride (NaCl), also known as common salt or table salt, is the world's oldest “food additive” and generally is the most important additive in the production of meat products. By percentage, salt consists of 39.3% sodium and 60.7% chloride and frequently contains a small amount of anti-caking agent in order to keep it free flowing over a long period of time. Oversupply of salt, or specifically the sodium part, is believed to lead to high blood pressure.

Sodium chloride fulfills several functions in meat and meat products. One function of salt in the preparation of the meat is as a flavour enhancer. Sodium chloride, in conjunction with phosphates, solubilises protein, which in turn can immobilize a large amount of added water, and is thus also able to emulsify fat in meat products. The addition of sodium chloride influences the interaction between actin and myosin, and is thus also capable of improving the texture.

Around 129 grams of added sodium chloride per kilogram of meat product is the lower limit to activate protein effectively. Additionally, sodium chloride lowers the amount of free water within a product (the Aw value). Sodium chloride in meat products, such as raw fermented salami or raw air dried products, is furthermore an important hurdle against microbiological spoilage during the initial stages of the production. The addition of sodium chloride favours the growth conditions for Gram-positive bacteria instead of Gram-negative bacteria. Quite a few pathogens, such as Salmonella spp. and E-coli are Gram-negative bacteria. Sodium chloride itself eventually becomes poisonous to bacteria by creating an electrolyte imbalance within the cell. The addition of sodium chloride to meat causes a slight move from the IEP (Isoelectric point) of the muscle tissue towards a more acidic pH value. Depending on the amount of sodium chloride added, the IEP can move from 5.2 to around 5.0. As a result, increased levels of water can be bound without changing the pH value of the meat itself, as the shift of the IEP from 5.2 to 5.0 widens the gap between pH value present in the meat and the IEP. For example, prior to the addition of sodium chloride, the pH gap in meat is 0.50 pH units (from 5.7 to 5.2) and after the addition of sodium chloride, the gap is 0.7 pH units (from 5.7 to 5.0). A larger gap between the two pH values increases the capillary effect of the muscle fibres, and an increased capillary effect, causes increased water holding capacity.

Another ingredient often used in meat is phosphates. Phosphates are salts of phosphoric acid and are widely applied in the meat industry. Phosphates fulfill several functions in meat products. Through the addition of sodium chloride as well as phosphates to a meat product, the muscular protein becomes soluble and solubilised, or activated. The protein can then immobilize high levels of added water as well as emulsify a larger amount of fat, given that the activated meat protein is an excellent emulsifier of fat. Nearly all phosphates, as well as blends of phosphates, utilized in the meat-processing industry, are alkaline phosphates and the addition of alkaline phosphates to slightly acidic meat leads to a rise in pH inside the meat product. A movement further away from the IEP takes place and enhanced water binding capacity of the protein is the result because greater electrostatic repulsive forces create larger gaps between actin and myosin and larger amount of added water can be bound. The addition of phosphate increases the ionic strength of the meat and increased ionic strength leads to a more severe degree of swelling from the muscle fibres and activation of protein. Enhanced levels of activated and swollen protein support the immobilization of added water to meat products and the emulsification of fat. Phosphates in general have a negative image as a food additive. Some reports link it to certain diseases, e.g. osteoporosis.

For proper emulsification in meat using emulsifiers it is required that the proteins are solubilised and not denatured. In products with a low content of NaCl and no added phosphate, the meat proteins are not solubilised during processing and the emulsion stability of the meat will thus be very poor which results in high cooking losses, fat separation and poor texture. Emulsifiers are in general only used in products such as liver sausages which are typically produced based on pre-cooked meat. The pre-cooking denatures the meat proteins and a stable emulsion can therefore only be obtained by the addition of a suitable emulsifier. Emulsifiers typically used in meat products include citric acid esters of mono- and diglycerides of fatty acids (E 472c) and mono- and diglycerides of fatty acids (E 471), which are normally added at a level around 3-5 g per kg of the total meat mass.

The main emulsifiers used in meat products are sodium caseinates. Also soy protein may have emulsifying properties. Low molecular weight emulsifiers are less frequently used in meat products. The main use of sodium caseinate and soy protein is in cold prepared high fat “emulsions”, e.g. from lard. However, sodium caseinate and soy protein are expensive ingredients and the use of them raises the costs of the end products.

In the meat industry emulsions are intermediate products that are included in the final sausage and other types of emulsified meat product recipes. Therefore, they should be able to undergo further processing like forming, smoking and heating. One important requirement for an emulsion in the meat industry is that it should be stable to heat. Meat emulsions are not necessarily emulsions in the scientific sense of the word. They are more like a system of finely divided fat or oil in a continuous water phase, or finely divided water in a continuous fat phase. Meat emulsions should therefore be seen as macroscopically homogenous fat/water systems.

Although there is a substantial amount of literature on the effect of stabilizers and low molecular weight emulsifiers on emulsions in general, this has not resulted in any extensive use of such combinations in meat products. Starch/emulsifier interactions have been studied intensively, but still this has not resulted in the application of their interaction effects in meat products.

WO 03/075682 relates to a food additive comprising carrageenan iota and SSL (sodium stearoyl-2-lactylate). The food additive, which has emulsifying and/or stabilizing properties, can be used in the food industry and in the production of food products. The food additive can replace caseinate and soy protein and it is said to be cost effective.

WO 2005/051095 relates to a method for stabilizing a food product by adding to fat containing food ingredients a cold dispersible emulsifier and a hydrocolloid stabilizer for providing a cold-prepared heat stable fat emulsion. Also described is a blend of a cold-soluble hydrocolloid stabilizer and a cold dispersible emulsifier capable of improving the stability of cold-prepared emulsified food products and to the use thereof as well as to an emulsified meat product which is cold-prepared and heat stabilized by such a blend.

Emulsified meat products, such as frankfurters and bolognas are normally produced with sodium chloride (NaCl) added at a level around 1.8% and with added phosphate. The added NaCl and phosphate are there in order to solubilise the meat proteins. The solubilisation of the meat proteins is essential in order to ensure a proper emulsification of the meat products. In products with a low content of NaCl and no added phosphate, the meat proteins are not solubilized during processing and the emulsion stability of the meat will thus be very poor, which results in high cooking losses, fat separation and poor texture.

For many years one of the most common trends within Health and Nutrition has been to reduce salt and/or sodium content in meat products. Too high levels of salt, and specifically sodium, can lead to high blood pressure, which is one of the main reasons for cardiovascular diseases. In addition there is a desire to remove phosphate from meat products as phosphate has a negative image among many consumers and is potentially involved in the development of certain diseases.

There thus still exists a need for emulsifiers for use in emulsified meat products with reduced salt content and, preferably, without the aid of phosphate.

### SUMMARY OF THE INVENTION

The present inventors have surprisingly found that an improvement of water and fat binding by addition of an emulsifier selected from salts of fatty acids having a chain of carbon atoms, from 12 to 22 to meat products with reduced sodium chloride content and preferably no added phosphate may be obtained. For example, the addition of 1% Na-stearate in a sausage with only 1.2% NaCl and no added phosphate resulted in an improved cooking yield. Additional improvement of cooking yield and texture was obtained by the addition of starch in the formulation.

The present invention thus relates to a method for preparing an emulsified meat product comprising adding to a meat product an emulsifier selected from salts of fatty acids containing C12-C22, which meat product comprises less than 1.8% w/w NaCl.

The invention further relates to the use of an emulsifier selected from salts of fatty acids containing C12-C22 for water binding and/or emulsifying and/or fat binding in a meat product comprising less than 1.8% w/w NaCl.

In yet another aspect, the invention relates to an emulsified meat product comprising an emulsifier selected from salts of fatty acids containing C12-C22, which meat product comprises less than 1.8% w/w NaCl.

### DETAILED DISCLOSURE OF THE INVENTION

As described above, disclosed herein is a method for preparing an emulsified meat product comprising adding to a meat product an emulsifier selected from salts of fatty acids containing C12-C22, which meat product comprises less than 1.8% w/w NaCl.

In particular the emulsifier is a cold-soluble emulsifier. In one aspect, the emulsifier is selected from the group of stearate and palmitate.

Emulsifiers are molecules which have both a hydrophobic end and a hydrophilic ends enabling mixing of lipids and water into an emulsion that does not separate. Emulsifiers can also improve the distribution of oil and fat. Conventional emulsifiers are produced from vegetable oils, animal fat and glycerol.

The emulsifier selected from salts of fatty acids containing C12-C22 in the present context may be a cold dispersible or cold soluble emulsifier which is suitable for use in the food industry. In one aspect, the emulsifier is one or more salts of a pure fatty acid or a mixture of fatty acids. In one aspect, the mixture of fatty acids is a mixture based on more than 50% stearic acid, 60% stearic acid, 70% stearic acid, 80% stearic acid, or 90% stearic acid in combination with other fatty acids for example predominantly palmitic acid. In another aspect, the fatty acid is pure stearic acid.

In the present context, “cold soluble” means that the emulsifier may dissolve in water without heating. The preferred emulsifier is selected from the group consisting of stearate(s) or palmitate(s) or a combination thereof.

In one aspect, the fatty acids containing C12-C22 are saturated fatty acids.

In one aspect, the salt of the fatty acid as described herein is of the alkali or alkali earth metal type.

Examples of stearates used in the present invention are alkali or alkali earth metal stearate, such as sodium stearate or potassium stearate. Examples of palmitates used in the present invention are alkali or alkali earth metal palmitate, such as sodium palmitate or potassium palmitate. A preferred emulsifier is provided by stearate such as sodium stearate or potassium stearate or a combination thereof.

In one aspect, the emulsifier is added in an amount of 0.6-2.0% w/w emulsifier, preferably 0.8% -1.8% w/w emulsifier, more preferably 0.8% -1.7% w/w emulsifier, more preferably 0.8% -1.6% w/w emulsifier.

In the present invention, meat refers to the flesh of any animal or animals, including but without limiting, pork, bovine, poultry, lamb, goat and fish. In one aspect, the meat product comprises 0-50% w/w fat, preferably 10-40% w/w fat, more preferably 15-30% w/w fat. In a further aspect, the meat product further comprises antioxidants and/or water and/or spices and mixtures thereof.

In one aspect, the meat product of the present invention is a processed meat obtained from raw meat.

In one aspect, the meat product comprises less than 1.8% w/w, such as 0.1-1.8% w/w NaCl, or less than 1.7% w/w such as 0.5-1.7% w/w NaCl, or less than 1.6% such as 0.8-1.6% w/w NaCl, or less than 1.4% such as 1.0-1.4% w/w NaCl.

In a further aspect, the meat product comprises less than 0.2% w/w, preferably less than 0.1% w/w, or substantially no added amount of phosphate.

In the present invention a meat product refers to any processed (e.g., heated, injected, diminished, crumed and/or cured) meat. In one aspect, the meat product is diminished before addition of the emulsifier such as a cold soluble emulsifier.

In one aspect of the present invention, the meat is ground or cut in a grinder or bowl chopper before addition of the emulsifier.

In one aspect, disclosed herein is a meat product comprising an emulsifier selected from salts of fatty acids containing C12-C22, which meat product comprises less than 1.8% w/w NaCl. In a further aspect, disclosed herein is an emulsified meat product which is cold-prepared and heat stabilized by a blend of emulsifier, such as an cold soluble emulsifier, and/or a hydrocolloid. The meat product is preferably a sausage or other emulsified meat product such as a luncheon meat. The present invention provides special benefits in food products which undergo heat treatment prior to consumption.

In one aspect, an emulsifier is added in combination with a stabilizer such as a hydrocolloid compound. In one aspect, the hydrocolloid compound is either added before, at the same time or later than the emulsifier. In a further aspect, the hydrocolloid is added at the same time as the emulsifier, and in particular at the beginning of the method for preparing the meat product of the present invention.

In a further aspect, the hydrocolloid is a cold-soluble hydrocolloid.

In a further aspect, the hydrocolloid compound is selected from the group consisting of alginate, xanthan, guar, pectin, carboxymethyl cellulose, carrageenan, starch, LBG (Locust Bean Gum) and combinations thereof.

In one aspect, hydrocolloid compound is starch, such as native starch. In a further aspect, the hydrocolloid compound is potato starch.

In one aspect, the hydrocolloid is added in an amount of 0.5-10% w/w hydrocolloid, preferably 1-6% w/w hydrocolloid, more preferably 2-4% w/w hydrocolloid. A preferred hydrocolloid in combination with the emulsifier comprises starch. In another aspect, the hydrocolloid in combination with the emulsifier comprises starch and carrageenan.

An especially preferred combination used in the method according to the present invention is where the emulsifier is stearate and the hydrocolloid is starch and/or carrageenan.

In the method according to the present invention the emulsifier and the hydrocolloid are preferably provided in a powder blend which can be dissolved in water. The resulting solution can then be used to make a pre-emulsion. Alternatively, the solution can be added directly to the meat food formulation. It is, however, also possible to add the emulsifier and hydrocolloid, preferably as a powder blend, directly to the meat product formulation, in which case the components will dissolve in water existing in the formulation.

In one aspect, fat (e.g. lard) and other ingredients needed for the meat product are mixed and the cold dispersible emulsifier and hydrocolloid are added to the mixture.

The emulsifier and hydrocolloid are preferably premixed in dry or semidry powder form to provide a blend. The blend is preferably dissolved in water to provide a solution which is then added to the food ingredients. The solution may be mixed with the fat (e.g. lard) or oil to provide a pre emulsion which is then combined with the other ingredients. Alternatively, the solution is mixed directly with the food ingredients to provide the desired emulsion. The emulsifier and hydrocolloid may also be added directly to the meat ingredients. In this case it is really preferred to mix the emulsifier and hydrocolloid into a blend before addition to the food ingredients to ensure uniform distribution of the components in the aqueous phase of the meat product.

The blend of the emulsifier and the hydrocolloid and the meat ingredients is cold prepared in order to preserve the raw materials. In one aspect, the addition of the emulsifier is at a temperature of -10 to 50° C., preferably -5 to 30° C., more preferably 0 to 15° C.

In one aspect, the meat product is a product which is heat treated prior to consumption. At the final production step the meat product is thus generally heated, wherefore it is important that the fat emulsion is heat stable. Mixing and emulsifying are performed in a conventional way used in the industry and no special equipment is required. The lard emulsions are usually prepared by diminishing lard in a water/ice mixture with high speed rotating knives.

The blend of the emulsifier and the hydrocolloid together provide a texture which is stable also when the fat emulsion is heated. This has not been achieved properly in the prior art with the ingredients used previously in cold prepared meat products. Another advantage of the method according to the present invention is that food products prepared by the method also have good firmness. The present invention enables the preparation of good quality final products in a cost effective way.

The meat product of the present invention is any processed (heated, injected, diminished, canned, cured) meat product containing fat and other ingredients which need to be emulsified. In a preferred embodiment the emulsion is also heat stable. Such meat products are different kinds of sausages and emulsified meat, such as luncheon meat. The various meat products are prepared in conventional ways even when a method according to the present invention is used.

The emulsions as described herein are macroscopically homogenous fat/water systems wherein the finely divided fat or oil is in a continuous water phase, or finely divided water is in a continuous fat phase. Thus, the emulsions as described herein are not actually emulsions in the strict meaning of the word. The preferred emulsions prepared according to the present method are also heat stable, i.e. their texture and composition is not affected by heating.

Therefore, they are easily further processed e.g. by forming, smoking and heating depending on the desired final product.

The stabilizers used in the present invention are hydrocolloid stabilizers. Hydrocolloids are special ingredients which may be used in emulsions with or without emulsifiers in order to make the emulsion stable.

Stabilizers ensure homogenous distribution and consistency of the emulsion. Stabilizers prevent e.g. sedimentation of the ingredients in the mixture and make sure that the mixture remains even.

The hydrocolloid stabilizers that perform well in the present invention are cold-gelling or cold soluble.

The preferred procedure whereby first a dispersion of the emulsifier/hydrocolloid blend in water is made allows the hydrocolloids to be dissolved in the absence of gelling ions that are provided by the other ingredients used in the food product.

Preferred hydrocolloids of the present invention are alginate, xanthan, guar, pectin, carboxymethyl cellulose, carrageenan, starch. Also LBG can be used in the present invention.

Alginates are linear unbranched polymers naturally found in brown seaweeds (Phaeophyceae, mainly Laminaria). Alginates are not random copolymers but, according to the source algae, consist of blocks of similar and strictly alternative residues each of which have differed conformational preferences and behaviour. They may be prepared with a wide range of average molecular weights (50-100000 residues) to suit the application.

Xanthan is an exocellular polysaccharide produced by fermentation of the bacteria Xanthomonas campestris, originally isolated from the rutabaga plant. It is a cream-coloured powder that is dissolved in water to produce a thick viscous solution at low concentrations. Xanthan remains stable over a wide temperature range and forms a strong film on drying.

Guar is a galactonlannan similar to locust bean gum consisting of a (I-4)-linked β-D-mannopyranose backbone with branch points from their 6-positions linked to α-D-galactose (i.e. 1-6-linked-α-D-galactopyranose). There are between 1.5-2 mannose residues for every galactose residue.

Alginate gels are very heat-stable which explains why alginate gives the hardest final products. Alginate is therefore the most preferred hydrocolloid of this invention. Also xanthan provides an especially good stabilizer for the present invention. The carrageenan used in the present invention can be any kind of carrageenan, such as iota, kappa, sodium and/or calcium carrageenan.

When Ca-sensitive hydrocolloids like alginate and carrageenan are used, Ca-salts and/or sequestrants may optionally be added to improve dissolution of the hydrocolloid and to control the rate of calcium dissolution. Examples of suitable Ca-salts are CaS0₄, CaHP0₄, CaCl₂, Ca-lactate, Ca-citrate and Ca-gluconate. Examples of suitable sequestrants are Na-phosphates, Na-pyrophosphates and Na-polyphosphates.

Fats are fatty acid esters of glycerol. The hardness of the fats depends on the degree of unsaturation of the fatty acids. A high degree of unsaturation causes softness of the fat. Animal fats have a high content of saturated fatty acids and they are mostly solid at room temperature.

The fat used in the present invention depends on the food product to be prepared. In some formulations of the present invention the fat is not solid at room temperature.

The other raw materials of the food products are chosen depending on the desired product. The hydrocolloid(s) and emulsifier(s) are used in proportions which are necessary in the product in question in order to provide cold prepared heat stable meat product. In one aspect, the ratio of emulsifier to hydrocolloid is from 1:2 to 1:9.

The hydrocolloid and emulsifier are preferably made into a premixed blend and dissolved in water before mixing with the other ingredients. A preferred blend, which has proven very efficient in practice, contains emulsifier and starch. The starch is preferably used as native or modified starch or in the form of a combination of native and modified starch.

Optionally the blend contains also Ca-salts and/or sequestrants. Preferable Ca-salts are CaS0₄, CaHP0₄, CaCl₂, Ca-lactate, Ca-citrate and Ca-gluconate. Generally the blend contains 0-20% Ca-salt, preferably 2-10%. Preferable sequestrants are Na-phosphates, Na-pyrophosphates and Na-polyphosphates. Generally the blend contains 0-20% sequestrant, preferably 1-10%.

The actual amount of Ca-salt and sequestrant to be added depends on the nature of the stabilizer and the environment provided by the other ingredients in the emulsion. These salts are used to control the properties like dispersability, solubility and gelation of the stabilizer.

The present invention also relates to the following numbered aspects:

1. A method for preparing an emulsified meat product comprising adding to a meat product an emulsifier selected from salts of fatty acids containing C12-C22, which meat product comprises less than 1.8% w/w NaCl.

2. The method according to aspect 1, wherein the emulsifier is a cold soluble emulsifier and/or wherein the fatty acids containing C12-C22 are saturated fatty acids.

3. The method according to aspect 1, wherein the emulsifier is a stearate and/or palmitate.

4. The method according to aspect 3, wherein the stearate is of the alkali or alkali earth metal type, such as sodium or potassium stearate.

5. The method according to aspect 3, wherein the palmitate is of the alkali or alkali earth metal type, such as sodium or potassium palmitate.

6. The method according to any one of aspects 1-5, wherein the emulsifier is added in an amount of 0.6-2.0% w/w, preferably 0.8% -1.8% w/w, more preferably 0.8%-1.7% w/w, more preferably 0.8%-1.6% w/w.

7. The method according to any one of aspects 1-6, wherein the meat product comprises less than 1.8% w/w NaCl, such as 0.1-1.8% w/w NaCl, or less than 1.7% w/w NaCl such as 0.5-1.7% w/w NaCl, or less than 1.6% NaCl such as 0.8-1.6% w/w NaCl, or less than 1.4% NaCl such as 1.0-1.4% w/w NaCl.

8. The method according to any one of aspects 1-7, wherein the meat product comprises less than 0.2% w/w, preferably less than 0.1% w/w, or substantially no added amount of phosphate.

9. The method according to any one of aspects 1-8, wherein the emulsifier is provided in combination with a hydrocolloid compound either added before, at the same time or later than the emulsifier.

10. The method according to aspect 9, wherein the hydrocolloid is a cold-soluble hydrocolloid.

11. The method according to aspect 9, wherein the hydrocolloid is added at the same time as the emulsifier.

12. The method according to aspect 9, wherein the hydrocolloid compound is selected from the group consisting of alginate, xanthan, guar, pectin, carboxymethyl cellulose, carrageenan, starch, LBG (Locust Bean Gum) and combinations thereof.

13. The method according to aspect 9, wherein the hydrocolloid is added in an amount of 0.5-10% w/w, preferably 1-6% w/w, more preferably 2-4% w/w.

14. The method according to any one of aspects 9-13, wherein the hydrocolloid compound is starch.

15. The method according to aspect 14, wherein the starch is native starch.

16. The method according to aspect 14, wherein the starch is potato starch.

17. The method according to any one of aspects 1-16, wherein the emulsifier is provided in combination with carrageenan either added before, at the same time or later than the emulsifier.

18. The method according to aspect 17, wherein the carrageenan is added at the same as the emulsifier.

19. The method according to aspect 17, wherein the carrageenan is added in an amount of 0.1-1.0% w/w, preferably 0.2-0.7% w/w, more preferably 0.3-0.5% w/w.

20. The method according to any one of aspects 1-19, wherein the addition of the emulsifier is at a temperature of −10 to 50° C. preferably −5 to 30° C., more preferably 0 to 15° C.

21. The method according to any one of aspects 1-20, wherein the meat is selected from the group of pork, bovine, poultry, lamb, goat, fish.

22. The method according to any one of aspects 1-21, wherein the meat product comprises 0-50% w/w fat, preferably 10-40% w/w fat, more preferably 15-30% w/w fat.

23. The method according to aspect 22, wherein the meat product further comprises antioxidants and/or water and/or spices and mixtures thereof.

24. The method according to any one of aspects 1-23, wherein the meat is diminished before addition of the emulsifier.

25. The method according to any one of aspects 1-24, wherein said meat product is a sausage or other emulsified meat product.

26. The method according to any one of aspects 1-25, wherein said meat product is a product which is heat treated prior to consumption.

27. Use of an emulsifier selected from salts of fatty acids containing C12-C22 for water binding and/or emulsifying and/or fat binding in a meat product comprising less than 1.8% w/w NaCl.

28. The use according to aspect 27, wherein the emulsifier is a cold soluble emulsifier.

29. The use according to aspect 27, wherein the emulsifier is stearate and/or palmitate.

30. The use according to aspect 29, wherein the stearate is of the alkali or alkali earth metal type, such as sodium or potassium stearate.

31. The use according to aspect 29, wherein the palmitate is of the alkali or alkali earth metal type, such as sodium or potassium palmitate.

32. The use according to any one of aspects 27-31, wherein the emulsifier is added in an amount of 0.6-2.0% w/w, preferably 0.8%-1.8% w/w, more preferably 0.8%-1.7% w/w, more preferably 0.8%-1.6% w/w.

33. The use according to any one of aspects 27-32, wherein the meat product comprises less than 1.8% w/w, such as 0.1-1.8% w/w NaCl, or less than 1.7% w/w such as 0.5-1.7% w/w NaCl, or less than 1.6% such as 0.8-1.6% w/w NaCl, or less than 1.4% such as 1.0-1.4% w/w NaCl.

34. The use according to any one of aspects 27-33, wherein the meat product comprises less than 0.2% w/w, preferably less than 0.1% w/w, or substantially no added amount of phosphate.

35. The use according to any one of aspects 27-34 as further defined in any aspects 9-24.

36. The use according to any one of aspects 27-35, wherein said meat product is a sausage or other emulsified meat product.

37. The use according to any one of aspects 27-36, wherein said meat product is a product which is heat treated prior to consumption.

38. An emulsified meat product comprising an emulsifier selected from salts of fatty acids containing C12-C22, which meat product comprises less than 1.8% w/w NaCl.

39. A meat product as further defined in any one of aspects 1-37.

All patents, patent applications, and published references cited herein are hereby incorporated by reference in their entirety. The disclosure set forth herein has been particularly shown and described with references to preferred embodiments thereof, it will be understood by those skilled in the art that various changes in form and details may be made therein without departing from the scope encompassed by the present disclosure.

The invention is illustrated below with the examples.

### EXAMPLES

### Exemplary Procedure for Preparing Sausages or Cups with Meat

Meat and fat is minced to 13 mm and mixed at a temperature of at 2° C. in a bowl chopper. The meat is further mixed with curing salt, optionally phosphate, and ⅓ of the ice/water in the chopper for 10 rounds at speed 1. A further ⅓ of ice/water and a dry blend of all other ingredients are added. The chopper is set at a speed of 2 till 5° C. Fat is added with the rest of ice/water. The chopper is cleaned—chopper speed 2 (vacuum till 0.8 bar) till 12° C. The temperature at the end is 12.5° C. The meat is either stuffed as sausages in F-plus Cal. 60 (plastic casing calibre 60 mm); stuffed in 10 cups; or stuffed in peal-able casings 19 mm.

The sausages is optionally smoked and cooked at the following settings:

| | Temperature in | | |
|---|---|---|---|
| Step | smoke house in ° C. | Time | Humidity |
| Curing | 40 | 15 | |
| Drying | 45 | 15 | |
| Smoking | 50 | 45 | |
| Cooking | 73 | 40 | 99 |
| Cooking with | 0 | 30 | |
| water | | | |

The meat in F-plus and bowls are cooked for 1 h at 75° C. in a steam oven.

### Description of Methods Used in the Trials:

### Cooking and Storage Loss

In each trial the meat paste was stuffed into 4 small square cups with 220 g of meat paste in each. The cups were sealed with plastic foil on the tray packing system with the temperature set to 220° C. After cooking the samples were put into the cooling room overnight at +2° C. After overnight storage, the meat blocks were removed from the cups and the weight was measured. After weighing, the meat blocks were subsequently vacuum packed on a vacuum packing machine. The samples were then kept for 1 week in the cooling room at +2° C. After 1 week the meat blocks were removed from the bags, dried and weighed.

### Sensory Evaluation

A sensory panel is formed. In the evaluation a 6 point scale is used. Attributes which are chosen for the evaluation is hardness (bite) and overall ranking. Additional comments about juiciness, off-taste etc. are also noted by the panel members. During preparation of the samples the whole sausages are heated to an internal temperature of 75° C.

### Texture Profile Analysis (TPA)

Texture measurements are made as a compression force test in a Texture Analyzer apparatus (Stable Micro Systems, UK). The meat paste is stuffed in 4 small square cups and caliber 60 mm plastic casing and measured with a probe P10 (diameter: 5 mm) after cooking and overnight storage at +2° C. The trigger force, compression distance and the rate of compression were respectively 5 g, 15 mm and 0.5 mm/s.

### Example 1

Texture, cooking and storage loss were tested in sausages at different dosage levels of sodium stearate.

The sausages had the following ingredients in w/w %:

Beef shoulder 22.5%
Pork shoulder 16.5%
Pork back fat 23.0%

### Ice/water q.b. (up to 100%)

Nitrite curing salt 1.5%
Ascorbic acid 0.05%

### Dextrose 1.0%

Sodium stearate in an amount as shown in table 1

TABLE 1
Ingredients and results

| | | Sodium | Sodium | |
|---|---|---|---|---|
| | | Stearate | Stearate | Sodium Stearate |
| | Control | 0.5% | 1.0% | 1.5% |
| Average cooking | 6.52% | 6.95% | 4.59% | 3.32% |
| loss | | | | |
| Average storage | 1.91% | 2.03% | 1.47% | 1.44% |
| loss | | | | |
| Total loss | 8.31% | 8.84% | 5.99% | 4.71% |
| Texture (Hardness) | 955 | 711 | 1003 | 1073 |

The above results show that both 1% and 1.5% dosage have a positive impact on yield, storage loss and texture in the sausage.

### Example 2

Texture, cooking and storage loss were tested with sausages having added a combination of sodium stearate and starch.

The sausages had the following ingredients in w/w %:

Pork shoulder (3%-6% fat) 22.5%
Beef shoulder 16.5%
Pork back fat 23.0%
Water tap q.b. Ascorbic acid 0.05%

### Dextrose 1.0%

### Wiener/Frankfurter Red 0.50%

Starch, sodium stearate, sodium tripolyphosphate and nitrite curing salt in an amount as shown in table 2

TABLE 2
Ingredients and results

| | Control | Recipe 2 | Recipe 3 | Recipe 4 | Recipe 5 | Recipe 6 | Recipe 7 | Recipe 8 |
|---|---|---|---|---|---|---|---|---|
| Nitrite salt | 1.80% | 1.80% | 1.20% | 1.20% | 1.20% | 1.20% | 1.20% | 1.20% |
| Phosphate | 0.3% | | | | | | | |
| Stearate | | | | 1.0% | 1.0% | 1.0% | | 1.0% |
| Starch | | | | | 1.0%* | 2.0%* | 2.0%* | 2.0%** |
| Average | 8.48% | 9.72% | 21.35% | 8.14% | 6.40% | 5.67% | 15.67% | 4.40% |
| cooking | | | | | | | | |
| loss | | | | | | | | |
| Average | 2.18% | 2.84% | 2.15% | 2.02% | 1.98% | 1.72% | 2.23% | 2.00% |
| storage | | | | | | | | |
| loss | | | | | | | | |
| Average | 10.65% | 12.57% | 23.50% | 10.16% | 8.38% | 7.39% | 17.90% | 6.40% |
| total loss | | | | | | | | |
| Texture | 646.4% | 565.2% | 442.5% | 442% | 538.2% | 520.0% | 497.5% | 668.2% |
| (Hardness) | | | | | | | | |

*N-Hance 6,
**N-Hance 59

The above results show that the cooking loss is increased when phosphate is removed from the formulation (recipe 2). Very high cooking loss can be seen where the salt content was reduced to 1.2% and no phosphate added (in recipe 3). This result clearly demonstrates the importance of salt in a sausage formulation. The above results also shows that a sausage with 1% Na-stearate (recipe 4) results in the same cooking loss as the control (recipe 1), even though the salt content is reduced to 1.2% and no phosphate was added. This result confirms the positive impact of Na-stearate in the formulation. The result of the addition of starch in combination with Na-stearate in recipe 5-8, results in a positive improvement in cooking loss. Starch in recipe 8 shows best functionality in combination with Na-stearate. In recipe 7 only 2.0% of starch was added and no Na-stearate which results in a very high cooking loss. The results from the texture analyzer show that recipe 4 with Na-stearate has a lower texture compared to the control in recipe 1. Addition of starch (N-Hance 59) in combination with Na-stearate in recipe 8 improves the texture and provides the same hardness as the control recipe.

### Example 3

Average cooking loss in sausages with either sodium stearate or potassium stearate was compared.

The sausages had the following ingredients in w/w %:

Pork shoulder (3%-6% fat) 22.5%
Beef shoulder 16.5%
Pork back fat 23.0%

### Water tap q.b.

Ascorbic acid 0.05%

### Dextrose 1.0%

Starch, nitrite salt 0.6%, KCl, sodium tripolyphosphate, Wiener/Frankfurter Red and either sodium or potassium stearate in an amount as shown in table 3.

TABLE 3
Ingredients and results

| | Control | Recipe 1 | Recipe 2 |
|---|---|---|---|
| Nitrite salt | 1.80% | 1.20% | 1.20% |
| Phosphate | 0.3% | | |
| KCl | | 0.8% | 0.8% |
| Starch | | 4.0% | 4.0% |
| Sodium stearate | | 1.0% | |
| Potassium stearate | | | 1.0% |
| Wiener/Frankfurter | 0.4% | 0.6% | 0.6% |
| Red | | | |
| Average cooking | 6.39% | 2.66% | 2.47% |
| loss | | | |

The above results show that there is no significant difference between adding sodium or potassium stearate to the sausages, hence potassium stearate can be used instead of sodium stearate in order to reduce the sodium content in the formulation. A sensory evaluation showed that the overall taste of the samples is improved with addition of KCl and extra spices.

1. A method for preparing an emulsified meat product comprising adding to a meat product an emulsifier selected from salts of fatty acids containing C12-C22, which meat product comprises less than 1.8% w/w NaCl.

2. The method according to claim 1, wherein the fatty acids containing C12-C22 are saturated fatty acids.

3. The method according to claim 1, wherein the emulsifier is a cold soluble emulsifier.

4. The method according to claim 1, wherein the emulsifier is a stearate of the alkali or alkali earth metal type, such as sodium and/or potassium stearate, and/or is a palmitate of the alkali or alkali earth metal type, such as sodium or potassium palmitate.

5. The method according to claim 1, wherein the emulsifier is added in an amount of 0.6-2.0% w/w, preferably 0.8%-1.8% w/w, more preferably 0.8%-1.7% w/w, more preferably 0.8%-1.6% w/w.

6. The method according to claim 1, wherein the meat product comprises less than 1.8% w/w NaCl, such as 0.1-1.8% w/w NaCl, or less than 1.7% w/w NaCl such as 0.5-1.7% w/w NaCl, or less than 1.6% NaCl such as 0.8-1.6% w/w NaCl, or less than 1.4% NaCl such as 1.0-1.4% w/w NaCl.

7. The method according to claim 1, wherein the meat product comprises less than 0.2% w/w, preferably less than 0.1% w/w, or substantially no added amount of phosphate.

8. The method according to claim 1, wherein the emulsifier is provided in combination with a hydrocolloid compound either added before, at the same time or later than the emulsifier.

9. The method according to claim 7, wherein the hydrocolloid is a cold-soluble hydrocolloid.

10. The method according to claim 7, wherein the hydrocolloid compound is selected from the group consisting of alginate, xanthan, guar, pectin, carboxymethyl cellulose, carrageenan, starch, LBG (Locust Bean Gum) and combinations thereof, such as starch.

11. The method according to claim 7, wherein the hydrocolloid is added in an amount of 0.5-10% w/w, preferably 1-6% w/w, more preferably 2-4% w/w.

12. The method according to claim 1, wherein said meat product is a sausage or other emulsified meat product.

13. Use of an emulsifier selected from salts of fatty acids containing C12-C22 for water binding and/or emulsifying and/or fat binding in a meat product comprising less than 1.8% w/w NaCl.

14. An emulsified meat product comprising an emulsifier selected from salts of fatty acids containing C12-C22, which meat product comprises less than 1.8% w/w NaCl.

15. A meat product as defined in claim 1.
